(19) United States
(12) Patent Application Publication
(10) Pub. No.: US 2018/0282601 A1
(43) Pub. Date: Oct. 4, 2018

(54) ABSORBANT HYACINTH PRODUCT AND RELATED METHOD OF MANUFACTURE

(71) Applicant: Vincent Gregory Shinault, Enterprise, FL (US)

(72) Inventor: Vincent Gregory Shinault, Enterprise, FL (US)

(21) Appl. No.: 15/478,876

(22) Filed: Apr. 4, 2017

(51) Int. Cl. C09K 3/32; B01J 20/24; B01J 20/28; B01J 20/30

(52) U.S. Cl. CPC C09K 3/32; B01J 20/24; B01J 20/3035; B01J 20/3021; B01J 20/2804

(57) ABSTRACT

A method provides a buoyant sheet of compacted water Hyacinth particles having a size of between 1/32 inches and 1/16 inches, and a moisture content 10 percent, and a plurality of dry Hyacinth particles having a size of between 0.001 and 1 inch, and a moisture content 10 percent.

### TECHNICAL FIELD

The present invention relates generally to absorbent material compositions, and more particularly to an absorbent Hyacinth product and method of manufacture.

### BACKGROUND

There are many known types of absorbent compositions that are used to contain liquid and small particle spills that occur on land and water. The majority of these known compositions utilize a plurality of different chemicals that are mixed with fillers such as sawdust, for example, that react to the introduction of a specific type of spilled material (such as oil or gasoline, for example). When mixed together, the chemicals within the composition bind with the spilled material and the entire mixture typically hardens into clumps which can be collectively removed from the surrounding environment.

However, there are several disadvantages associated with the known absorbent compositions. For example, as the majority of these compositions are designed and chemically treated to specifically bind with a single type of spilled material, they are not effective for use with other types of spilled materials.

With regard to oil and chemical spills in waterways, the two most commonly utilized methods for removing the same are: 1) utilizing booms to surround and isolate petroleum/oil pollutant slicks, and then use surface skimmers to scoop the same into containment tanks; and 2) use chemical dispersants to break down the petroleum/oil slick into droplets, thereby allowing the same to mix with the water and to be absorbed into the aquatic system.

Both of these methods have significant drawbacks because the first method is difficult to employ in rough waters and requires the use and implementation of heavy equipment and a power source to operate the skimmer, whereas the second method results in a significant amount of pollution remaining in the aquatic environment.

The present invention, directed to a biodegradable absorbent product and related method of manufacture differs from the foregoing approaches in a number of aspects. The manner by which will become more apparent in the description which follows, particularly when read in conjunction with the accompanying drawing.

### SUMMARY OF THE INVENTION

The present invention is directed to an absorbent Hyacinth product and a method of manufacturing the same.

In one embodiment, the product includes a buoyant sheet of compacted water Hyacinth particles having a size of between 1/32 inches and 1/16 inches, and a moisture content of 10 percent. The buoyant product can be formed into large sheets that can float on a body of water to remove contaminants from the surface thereof.

In another embodiment, the product includes a plurality of dry Hyacinth particles having a size of between 0.001 and 1 inches, and a moisture content of 10 percent. The product can function alone or in conjunction with secondary absorbents to remove liquid spills on land.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a process flowchart for preparing absorbent Hyacinth products according to a current embodiment.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described throughout this document, the presently claimed invention contemplates the use and transformation of Eichhornia crassipes, commonly referred to as water Hyacinth. As is known, the water Hyacinth is an invasive plant species that is located in most of the South, Central and North American waterways. The species is problematic due to its rapid reproduction cycle, and if left unchecked has a propensity to cover the entire surface area of lakes and ponds, thereby preventing sunlight from reaching the water and killing most of the life therein. Moreover, the species is a prime habitat for mosquitos and contributes to the spread of mosquito-borne diseases.

To this end, many public and private water management industries spend countless dollars each year to remove the water Hyacinth from these waterways. Once removed, the plants are sent to landfills. Unfortunately, due to the overwhelming volume of material, many landfills are refusing to accept the removed material, thus causing additional problems and cost for such industries.

Through extensive research and study, the inventors of the present application have developed a novel method and system for transforming the heretofore unwanted and burdensome water Hyacinth into a composition of matter which can be formed into any number of different shapes, and that can be used to effectively absorb any type of material spills on dry land or on the water.

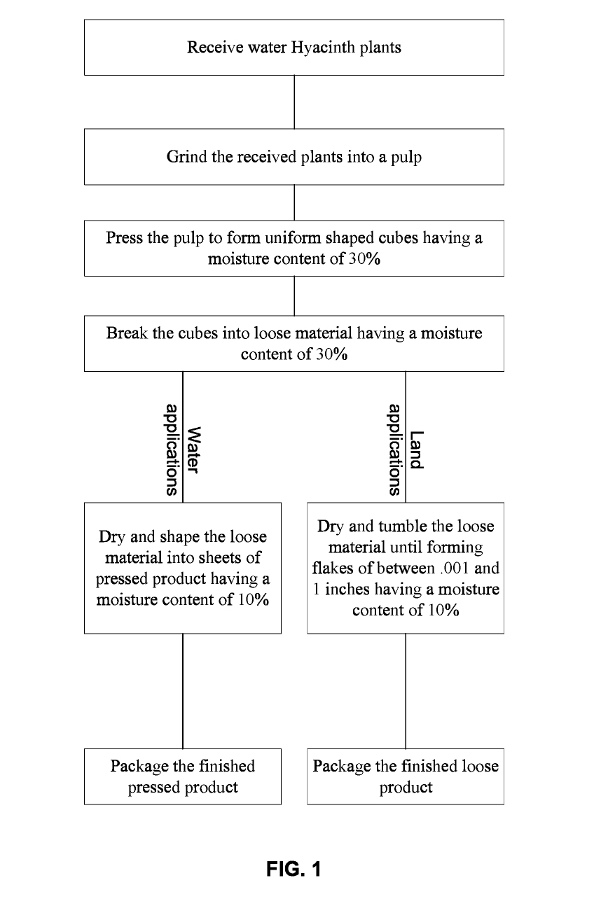

One embodiment of a method for creating a biodegradable absorbent product can include the following steps, which are generally illustrated in the flowchart of FIG. 1. Other features of the current embodiments will become apparent in the course of the following descriptions, which are given for illustration of the current embodiments, and are not intended to be limiting thereof.

Step 1. Acquiring water Hyacinth. In various embodiments, the water Hyacinth can be extracted from any body of water utilizing conventional methods such as manual tools and/or mechanical harvesters, for example.

Step 2, Grinding the water Hyacinth into a pulp. In the preferred embodiment, the water Hyacinth collected in step 1 will be reduced to a particle size of between 1/32″ and 1/16,” and will have a moisture content of approximately 95%. It is preferred that the grinding procedure be performed at the removal site via a commercial grinder, such as a tub grinder, for example. Of course, other embodiments are contemplated wherein the water Hyacinth can be ground to any number of different sizes onsite or at other locations using any type of other equipment.

At step 3, the moisture content of the pulp can be reduced to 30%, and the output can be formed into any number of desirable shapes and consistencies. In the preferred embodiment, the pulp from step 2 can be fed into an onsite press, such as a belt fed linear hydraulic press, for example, which imparts approximately 200 pounds of pressure per square inch onto the pulp. This pressure acting to form uniform cubes having a preferred size of approximately 3 feet by 3 feet, and a moisture level of 30%. The 30% moisture level having been found to be the optimum moisture level required to form the pulp into cubes that maintain their shape during transport with the minimum amount of water weight.

Of course, other embodiments are contemplated wherein the pulp is formed into any number of other shapes, sizes and/or moisture content. To this end, the product from step 2 can be fed into any number of mold trays having an unlimited number of different shapes and sizes. Once positioned therein, the product can be engaged by a press, as described above for transport.

At step 4, the cubes from step 3 can preferably be transported to a processing facility wherein they can be fed into a commercial tumbler. The tumbler can function to break the cubes into loose material having a moisture content of 30% for use in subsequent steps.

At step 5, the loose product from step 4 can be heated to approximately 185 degrees Fahrenheit for six hours to further reduce the moisture content of the product to 10% and to remove harmful bacteria. Moreover, during the heating procedure, the product can be fed into a second press, such as a belt filter press, for example, that imparts a force of approximately 200 pounds of pressure per square inch onto the product so as to form elongated sheets of pressed product.

When reduced to 10% moisture level through the above described process, the inventor has discovered that the resulting pressed product readily absorbs petroleum products. As such, the temperature of the drying process of step 5 is an important factor, as temperatures less than 180 degrees require longer periods of drying time which can break down the structural integrity of the fibers, thereby eliminating the absorbent ability of the finished product. Conversely, temperatures over 190 degrees cause the product to become scorched and/or combustible, thereby destroying the product.

Step 6. At the conclusion of the drying process, the resulting pressed product can be cut into any number of different shapes that can be packaged and shipped to any needed location.

In operation, the pressed sheets can most preferably be utilized to remove contaminants on the surface of bodies of water. For example, in the case of a chemical, petroleum and/or oil spill, any number of sheets can be transported to the site of the spill. Upon arrival, users can simply lay the sheets on the surface of the water containing the contaminants. Owing to the above noted manufacturing and drying procedures, the pressed product sheets are buoyant and will float along the surface of the water where the contaminants are located.

When so positioned, each sheet can be in direct contact with the contaminant(s) and can actively absorb the same. As each sheet becomes saturated with contaminants, they can be individually removed, thereby taking the contaminants with them.

Such a procedure can be accomplished without the need for the specialized equipment associated with traditional methods. Moreover, this process also advantageously allows the used sheets to be pressed on site or transported to a reclamation center where a press or other such equipment can be utilized to recapture the spilled contaminants.

Although described above with regard to pressed sheets for use in aquatic environments, other embodiments are also contemplated. To this end, the manufacturing method described above can also include step 4a, wherein the loose product from step 4 can be dried at a temperature range of no less than 180 degrees and no more than 190 degrees. In the preferred embodiment, the drying process can be performed simultaneously with the tumbling, so as to result in loose flakes ranging between approximately 0.001 and 1 inch in diameter at a moisture level of 10%.

Such dimensions being particularly advantageous, as it allows the flakes to be utilized alone, or in conjunction with other known absorbents such as wood pulp, for example, to absorb any number of different types of liquid spills on land. In such an instance, the output from step 4a can proceed to step 6 wherein the flakes can be packaged and shipped.

Although contemplate for use as an end product for removing contaminants from land and water, other embodiments are contemplated wherein the above noted products can be combined with other types of materials having an absorbent nature. Several nonlimiting examples include, but are not limited to paper towels, cleaning pads, biofuel and clothing, for example. Such features being possible and more effective than traditional counterparts owing to the high fiber content of water Hyacinth.

Although described above as utilizing particular machinery and/or steps in a particular order, this is for illustrative purposes only. To this end, those of skill in the art will recognize that any number of different types of machinery can be utilized in conjunction with, or as an alternative to the above described equipment without deviating from the scope and spirit of the inventive concepts disclosed herein. Additionally, the above noted steps may also be performed in an order that is different than that described above.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of preparing an absorbent sheet, comprising:
receiving water Hyacinth plants;
grinding the received Hyacinth plants to form a pulp;
forming the pulp into a first shape at a first moisture level;
breaking the first shape into loose material at the first moisture level:
heating the loose material at a first temperature to reduce a moisture amount to a second moisture level;
forming the loose material at the second moisture level into an elongated sheet; and
cutting the sheet to form a second shape for packaging and transport.

2. The method of claim 1, wherein the grinded pulp results in the water Hyacinth having a particle size of between 1/32 inches and 1/16 inches, and a moisture content of approximately 95%.

3. The method of claim 1, wherein the first shape is a cube.

4. The method of claim 3, wherein the first moisture level is 30 percent.

5. The method of claim 1, wherein the breaking is performed by an air tumbler.

6. The method of claim 1, wherein the first temperature is no less than 180 degrees Fahrenheit and no more than 190 degrees Fahrenheit for a time of 6 hours.

7. The method of claim 1, wherein the second moisture level is 10 percent.

8. The method of claim 1, wherein the breaking and heating are preformed simultaneously.

9. The method of claim 1, wherein the forming is performed by a belt press imparting a force of 200 pounds of pressure per square inch.

10. An absorbent sheet of Hyacinth product produced by the method of claim 1, the product comprising:
a buoyant sheet of compacted water Hyacinth particles having a moisture content 10 percent.

11. A method of preparing an absorbent product, comprising:
receiving water Hyacinth plants;
grinding the received Hyacinth plants to form a pulp;
forming the pulp into a first shape at a first moisture level;
breaking the first shape into loose material at the first moisture level:
heating the loose material at a first temperature to reduce a moisture amount to a second moisture level; and
packaging the loose material at the second moisture level.

12. The method of claim 11, wherein the grinded pulp results in the water Hyacinth having a particle size of between 1/32 inches and 1/16 inches, and a moisture content of approximately 95%.

13. The method of claim 11, wherein the first shape is a cube.

14. The method of claim 13, wherein the first moisture level is 30 percent.

15. The method of claim 11, wherein the breaking and heating are performed by a heated air tumbler.

16. The method of claim 15, wherein the first temperature is no less than 180 degrees Fahrenheit and no more than 190 degrees Fahrenheit for a time of 6 hours.

17. The method of claim 1, wherein the second moisture level is 10 percent.

18. The method of claim 11, wherein the packaged loose material comprises flakes having a dimension of between 0.001 and 1 inch at a moisture level of 10 percent.
